(19) United States
(12) Patent Application Publication
(10) Pub. No.: US 2026/0227484 A1
(43) Pub. Date: Aug. 6, 2026

(54) Fast and Efficient Multistatic Radar Measurements in a Cellular Communications System

(71) Applicant: Telefonaktiebolaget LM Ericsson (publ), Stockholm (SE)

(72) Inventors: Magnus Nilsson, Lund (SE); Peter Jakobsson, Lund (SE); Magnus Sandgren, Staffanstorp (SE); Peter Almers, Limhamm (SE)

(21) Appl. No.: 19/147,026

(22) PCT Filed: Jan. 10, 2023
(86) PCT No.: PCT/EP2023/050462

§ 371 Date: Jul. 10, 2025

(51) Int. Cl. G01S 7/00; G01S 13/00; G01S 13/86

(52) U.S. Cl. CPC G01S 7/006; G01S 13/003; G01S 13/86

(57) ABSTRACT

A cellular communication system that comprises a first node (101, 201, 301, 401, 501, 601, 701, 801, 901, 101) senses a first object by using a narrowband receiver of the first node (101, 201, 301, 401, 501, 601, 701, 801, 901, 101) to simultaneously receive (1403) a plurality of different directional narrowband receive beams (309, 807). A first directional narrowband receive beam is identified (1403) therefrom, wherein a first signal received in the first directional narrowband receive beam is associated with a first reflection from the first object. A receive direction of the first directional narrowband receive beam is used (1405) as a first estimate (313) of a direction of the first object relative to the first node (101, 201, 301, 401, 501, 601, 701, 801, 901, 101). The first estimate (313) of the direction of the first object and additional information are used (1407) to derive a first estimate (111, 209) of a position of the first object.

### BACKGROUND

The present invention relates to technology that enables fast and efficient bistatic/multistatic radar measurements to be made in a cellular communications system.

The demand for wireless communication systems to provide higher bitrates continues to increase. As low frequency spectrum fills up, higher frequency spectrum has been taken into use in an effort to meet this increasing demand. For example, a new frequency range, FR2 (24250 MHz-52600 MHz), has been introduced in the 5G cellular system. Additionally, beamforming has been introduced into 5G systems to increase both capacity and coverage. In the FR2 band, beamforming has been used mainly to combat the higher pathloss associated with higher frequencies. Beamforming and beam-steering are made by coherently combining RF signals from small antenna elements. A desired beam is formed by controlling the phase-shift and amplification applied to the signals at different antenna elements. This technology mitigates the above listed problems by radically increasing beam gain, thereby restoring the rated equivalent isotropic radiated power (EIRP) rating and the equivalent isotropic sensitivity (EIS) of mmW base stations to usable levels.

Beamforming can be obtained in many ways. The following is a brief review of basic methods.

A popular, low complexity way of forming beams utilizes analog processing. Here, the signals to and from the antennas are beamformed in the RF domain, close to the antenna. The rest of the signal chain is common to all or a portion of the antenna elements. In this arrangement, all the data is converted into a time domain stream early, before it is sent to the radio circuitry and antennas. Since one set of beam weights is applied during the duration of one Orthogonal Frequency Division Multiplexing (OFDM) symbol, the beam is therefore spatially fixed for all data. Although it may have peaks in multiple directions, the data stream is transmitted through one beam pattern, which limits the possibility of simultaneously transmitting data to multiple users. This creates problems when it is desired to direct different data streams in different directions, by frequency selective scheduling. In addition, problems are created when the User Equipment (UE) is trying to find the base station for initial access. Present FR2 Advanced Antenna Systems (AAS) use beam sweeping or wider initial beams to combat these issues, but this adds cost in terms of coverage, latency and/or capacity.

An alternative technology for generating beams is Frequency Selective Digital Beamforming (FS-DBF), which uses late Inverse Fast Fourier Transform (IFFT) processing to transform complex Orthogonal Frequency Division Multiple Access (OFDMA) symbols to data streams in time, with each user accessing all antenna elements independently, thereby allowing frequency selective beam forming. It allows for the use of Multiple User-Multiple Input Multiple Output (MU-MIMO) technology, where the users can be multiplexed, both spatially and in the frequency domain. But doing so requires that IFFT processing be performed on a per antenna basis, and this is computationally heavy. Additionally, all this processing generates a large quantity of data that needs to be transferred from one place to another, and this in turn means that interface bitrates must be extremely high. This is especially cumbersome with the number of antennas approaching 1000 and with channel bandwidths exceeding 1 GHz.

Distributed digital beamforming can be used to combat the problem of high bitrates when using FS-DBF with a high number of antennas. Then the Frequency Division Multiplexing (FDM) and Space Division Multiplexing (SDM) advantages are retained. However, these solutions do not allow access to individual antenna elements, so beam sweeping is required in the Uplink (UL) for UE directional finding.

WO2021223892 discloses technology that mitigates the problems with distributed digital beamforming. A parallel narrowband receiver extracts a small frequency portion from each antenna element and sends that for digital processing. The narrowband signals received are sufficient for estimation of the main directions of the received signal. These narrowband directions are used to form a digital non-frequency selective beamformer (NFS-DBF) applied over the full bandwidth. By only selecting a few significant beams in the NFS-DBF the number of spatial signal streams that are processed is reduced compared to the processing that would be required for all the antennas streams directly as in the FS-DBF case. As a result, a wideband reception that retains a high Signal-to-Noise Ratio (SNR) is secured, while the number of data streams that need to be interfaced for further combining is reduced to just one for each direction.

A recent addition to Third Generation Partnership Project (3GPP) systems is Integrated Access and Backhaul (IAB), where part of the huge capacity offered by the wide bandwidths in FR2 is used for backhaul traffic. This promises good cost savings by avoiding the need for inter-base station communication via fiber or Mini-link.

Future 3GPP systems, both 5G advanced and 6G, are considering adding integrated radar/sensing capability, both to improve communication system performance and to enable new end-user services like presence detection, positioning, and traffic surveillance. AAS base stations are particularly useful for radar since they include advanced beamforming capability. In addition, they are accurately positioned using GPS or similar technology, so locations determined relative to a base station are easily converted to, for example, accurate map coordinates.

Radar can be divided into several types that are well known in the art: monostatic radar and bi/multistatic radar. If a base station were to be used as a monostatic radar station, it would have to receive and transmit at the same frequency. Such an operating mode is normally not possible by default due to hardware reuse and stringent isolation requirements between transmission and reception operations.

In the bi/multistatic class of radars, two or more nodes are involved in the radar operation and each node is either transmitting a radar signal or receiving radar reflections. Base stations can readily function in this manner, and this is relied on in technology described herein.

In typical deployments, all base stations in a region are synchronized so that they transmit and receive at the same time. To enable several base stations to operate together as a bi/multistatic radar system, each receiving base station needs using a Time Division Duplex (TDD) scheme/schedule that is the reverse of the transmitting base stations. Since IAB already requires communicating base stations to operate in this way (i.e., with one transmitting during the node's downlink slots while the other is receiving), the inventors of the subject matter described herein have, through the use of inventive skill and investigation, determined that this functionality can be utilized to enable base stations to operate together as a bi/multistatic radar system. A benefit with IAB is that it also enables a fast communication channel between base stations and can provide a good timing reference for radar operation. It is noted, however, that the use of IAB is not an essential aspect of inventive embodiments; it is only a good illustration of an exemplary use case.

By using a base station with a large antenna array at each end of the radar system, good angular resolution and thus good object positioning and velocity estimation are achieved.

However, if the system relies on analog beamforming and uses only a single beam at a time, scanning a full service-area will take a considerable amount of time. In millimeter wave (mmW) base stations, each base station has several hundreds of antenna elements and correspondingly hundreds of possible beam-directions. The combination of two base stations in radar bi-static operation would then require 10,000 to 100,000 measurements to scan a full service area. This will become very time and resource consuming if operation is limited to using only a few beams at a time.

Therefore, there is a need for technology that will enable nodes (e.g., base stations) in a cellular communications system to perform bi/multistatic radar sensing in a way that addresses the above and/or related problems.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

Moreover, reference letters may be provided in some instances (e.g., in the claims and summary) to facilitate identification of various steps and/or elements. However, the use of reference letters is not intended to impute or suggest that the so-referenced steps and/or elements are to be performed or operated in any particular order.

In accordance with one aspect of the present invention, the foregoing and other objects are achieved in technology (e.g., methods, apparatuses, nontransitory computer readable storage media, program means) that is for sensing a first object in a cellular communication system that comprises a first node. This comprises using a narrowband receiver of the first node to simultaneously receive a plurality of different directional narrowband receive beams. A first directional narrowband receive beam is identified therefrom, wherein a first signal received in the first directional narrowband receive beam is associated with a first reflection from the first object. A receive direction of the first directional narrowband receive beam is used as a first estimate of a direction of the first object relative to the first node. The first estimate of the direction of the first object and additional information are used to derive a first estimate of a position of the first object.

In another aspect of some but not necessarily all embodiments consistent with the invention, the first reflection from the first object is a reflection of a first signal transmitted by a second node of the cellular communication system, and the additional information comprises relative positions of the first node and the second node and a signal propagation time from a radar transmitter of the second node to the first object and then to the first node, which together may be used to determine a first elliptical region.

In yet another aspect of some but not necessarily all embodiments consistent with the invention, the first signal transmitted by the second node is a first wide area narrowband signal.

In still another aspect of some but not necessarily all embodiments consistent with the invention, the sensing comprises communicating information to the second node for directing a transmit beam from the second node towards the first object.

In another aspect of some but not necessarily all embodiments consistent with the invention, the sensing comprises using a wideband radio receiver of the first node to receive a first directional wideband receive beam, wherein the first directional wideband receive beam has a direction based on a direction of the first directional narrowband receive beam and a second signal received in the first directional wideband receive beam is associated with a second reflection from the first object. The second signal received in the first directional wideband receive beam is used to determine a refined estimate of the position of the first object.

In yet another aspect of some but not necessarily all embodiments consistent with the invention, the second reflection from the first object is a reflection of a second signal transmitted by the second node of the cellular communication system.

In still another aspect of some but not necessarily all embodiments consistent with the invention, the second signal is, in some alternatives, a first wide area wideband signal; and in other alternatives is a first directional wideband signal.

In another aspect of some but not necessarily all embodiments consistent with the invention, sensing comprises using the narrowband radio receiver of the first node to receive a second directional narrowband receive beam, which is in a similar direction to the first directional narrowband receive beam, wherein: a third signal received in the second directional wideband receive beam is associated with a third reflection from the first object; the third reflection from the first object is a reflection of a third signal transmitted by a third node of the cellular communication system; and the additional information comprises relative positions of the first node and the third node and a signal propagation time from a radar transmitter of the third node to the first object and then to the first node, which together may be used to determine a second elliptical region.

In yet another aspect of some but not necessarily all embodiments consistent with the invention, the sensing comprises determining the position of the first object to be in a region of overlap between the first elliptical region and the second elliptical region.

In still another aspect of some but not necessarily all embodiments consistent with the invention, the third reflection from the first object is a reflection of a second narrowband signal transmitted by the third node of the cellular communication system.

In another aspect of some but not necessarily all embodiments consistent with the invention, the sensing comprises using the wideband radio receiver of the first node to receive a second directional wideband receive beam, wherein the second directional wideband receive beam has a direction based on a direction of the first directional narrowband receive beam, wherein a second signal received in the second directional wideband receive beam is associated with a fourth reflection from the first object. Further, the second signal received in the first directional wideband receive beam is used to determine a further refined estimate of the position of the first object.

In another aspect of some but not necessarily all embodiments consistent with the invention, the sensing comprises receiving a further narrowband reflection from the first object, wherein the further-narrowband reflection is separated in frequency from the first narrowband reflection.

In yet another aspect of some but not necessarily all embodiments consistent with the invention, the narrowband receiver receives the further reflection at a different time to the first reflection.

In still another aspect of some but not necessarily all embodiments consistent with the invention, the first node comprises a first narrowband receiver and a second narrowband receiver; and the first and second narrowband reflections are received concurrently by respective ones of the first and second narrowband receivers.

### BRIEF DESCRIPTION OF THE DRAWINGS

The objects and advantages of the invention will be understood by reading the following detailed description in conjunction with the drawings in which:

FIG. 1 illustrates an exemplary embodiment in which transceivers at two nodes of a cellular communication system are configured to operate in a bistatic radar mode.

FIGS. 2, 3A, 3B, 3C, and 3D illustrate embodiments in which three nodes are configured in accordance with a multistatic radar strategy.

FIGS. 4A, 4B, 4C, and 4D illustrate inventive embodiments in which two nodes are configured as a bistatic radar system.

FIGS. 5A, 5B, 5C, and 5D illustrate three nodes configured in another alternative embodiment that combines some aspects of the embodiment of FIGS. 3A, 3B, 3C, and 3D with some aspects of the embodiment of FIGS. 4A, 4B, 4C, and 4D.

FIGS. 6A, 6B, 6C, and 6D illustrate yet another alternative embodiment in which two nodes are configured to operate as a bistatic radar system.

FIGS. 7A, 7B, 7C, and 7D illustrate an alternative class of inventive embodiments in which several nodes are configured in a multistatic radar arrangement involving the use of directional wideband transmission beams in the second phase of operation combined with the use of plural radar transmission nodes.

FIG. 8 illustrates alternative embodiments in which the initial transmission from a second node in the first phase of operation is made using one or several directional narrowband transmission beams.

FIG. 9 illustrates a multistatic radar arrangement in which one node operates as a radar signal transmitter, and in which plural other nodes are each configured to receive a radar reflection signal.

FIGS. 10A, 10B, 10C, and 10D illustrate an alternative class of inventive embodiments comprising two nodes that are configured in a bistatic radar arrangement such that the nodes' roles as transmitter and receiver are swapped in successive phases of operation.

FIG. 11 is, in one respect, a flowchart of actions of plural network nodes that operate together as a bi/multistatic radar system in some embodiments.

FIG. 12 is, in one respect, a flowchart of actions of plural network nodes that operate together as a multistatic radar system in some alternative embodiments.

FIG. 13 is, in one respect, a flowchart of actions of plural network nodes that operate together as a bi/multistatic radar system in some further alternative embodiments.

FIG. 14 is, in one respect, a flowchart of actions of plural network nodes that operate together as a bi/multistatic radar system in some additional alternative embodiments.

FIG. 15 shows an exemplary controller that may be included in a network node to cause any and/or all of the herein-described and illustrated actions associated with a node to be performed.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits alone, one or more programmed processors, or any combination of these). Moreover, the invention can additionally be considered to be embodied entirely within any form of non-transitory computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments as described above may be referred to herein as “logic configured to” perform a described action, or alternatively as “logic that” performs a described action.

An aspect of inventive embodiments is the use of a narrowband receiver to detect the direction of a narrowband radar reflection. The received narrowband radar reflection can be used for both directional finding and coarse distance measurements. Wideband signals would produce both accurate direction and accurate distance estimates, but using wideband signals associated with many directions produces a very heavy processing load. For this reason, narrowband signals (which produce less data to be processed than wideband signals) are used in an initial sensing step. Then, a better estimate of distance is used based on the initial estimate of direction and additional information (e.g., obtained in one or more additional radar sensing operations).

A number of exemplary embodiments are described in the following. In these examples, there is a distinction between coarse and fine synchronization:
Coarse synchronization refers to a degree of accuracy that is sufficient to find a properly designed radar pulse and its direction, but insufficient to do a distance measurement. For example, the 3GPP (4G-5G) inter-base station TDD cell phase synchronization requirement of ±1.5 μs is herein considered coarse synchronization because it is sufficient to find a properly designed radar pulse and its direction, but ±1.5 μs corresponds to ±450 m, which is insufficient to do a distance measurement.

Fine synchronization refers to a level of synchronization between base stations that is good enough to make accurate distance measurements. The actual requirement depends on the ranging accuracy needed, but is typically several order of magnitude more stringent than the 3GPP requirements. For example, an inaccuracy of ±3.3 ns gives a distance uncertainty of ±1 m.

### Additionally, the Meaning of Several Terms As Used Herein Is As Follows:

“Accuracy” refers to the difference between the true positioning and the mean of the estimated positioning. A biased data and/or estimator will give an offset to the true value and reduce the accuracy. For example, poor synchronization or base station positioning could lead to a reduced accuracy.
“Precision” refers to the spread between different positioning estimates. For example, a low signal-to-noise ratio (SNR) results in less precision compared to a high SNR.
“Resolution” refers to the ability to separate multi-path components (i.e., multiple reflection points) in direction and/or distance. The directional resolution depends on the aperture of the antenna array (the largest distance between two antenna elements) and the larger the aperture the higher the directional resolution. The distance resolution depends on the signal bandwidth and the larger the bandwidth the higher the distance resolution.
“Distance uncertainty” refers to the overall distance estimate uncertainty including accuracy, precision and resolution. For example, the uncertainty associated with estimating the distance to one multipath component depends on SNR, synchronization errors, and distance resolution. A substantial consideration in this description is the effect that resolution has on distance uncertainty, and the effect of reference signal bandwidth on resolution. If multipath components are not resolved (i.e., multipath components with similar distance, such as reflections from multiple objects that are close to each other) the estimation uncertainty will increase. Increasing the reference signal bandwidth improves the resolution and therefore also reduces the uncertainty.

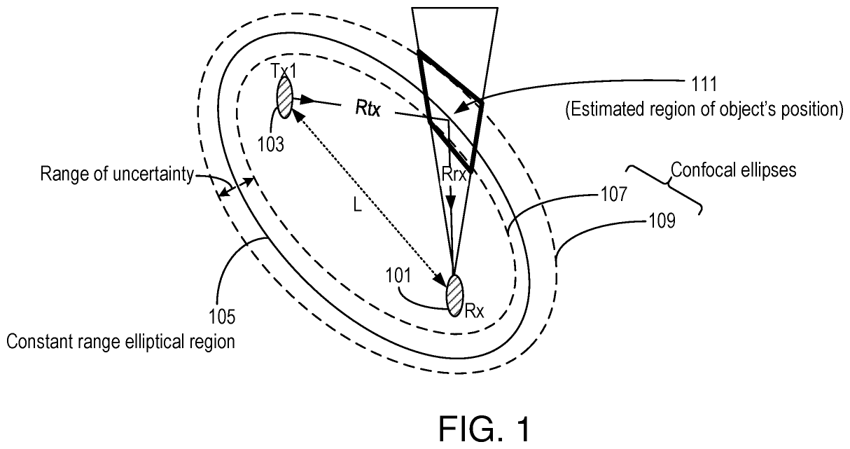

FIG. 1 illustrates an exemplary embodiment in which transceivers at two nodes of a cellular communication system are configured to operate in a bistatic radar mode. In this embodiment, fine synchronization between the base stations is employed by, for example using line of sight path between the base stations as a timing reference together with radio frequency (RF) are propagation delay compensation derived from knowledge of the base station positions (or if non-line of sight—NLOS—a round trip time (RTT) based method for inter-base station synchronization). Various methods can be used for inter-base station synchronization.

One of these involves the use of over the air synchronization. In such embodiments, the bandwidth of the signal used impacts the accuracy of synchronization. An accurate synchronization between transmitter and receiver in bistatic radar operation is one important pre-requisite for accurate ranging (i.e., a wider bandwidth results in a better degree of synchronization and thereby a more accurate ranging estimate). Various forms of over the air synchronization could be used, either separated from the radar sensing reception or performed simultaneously (i.e., the same transmitted signal is used both for sensing and as a synchronization reference at the receiver (which can be either a LOS or a NLOS path of the transmitted signal).

In this embodiment, a first node 101 (e.g., a first base station) uses its narrowband receiver (Rx) to receive narrowband radar reflection signals. A narrow bandwidth (NB) wide area (e.g., covering a cell sector, omnidirectional, etc.) radar signal is transmitted from a second node 103 (e.g., a second base station). The narrowband radar signal reflects off of an object, and its narrowband reflection is received in a first directional receive beam by a narrowband receiver of the first node 101.

The first node 101 comprises a narrowband receiver coupled to an antenna panel having a plurality of antenna elements. In order to detect radar reflections coming from a number of possible directions, it is advantageous to configure the plurality of antenna elements to form narrowband receive beams pointing in different respective directions, and to configure the node 101 to use the narrowband receiver and the configured plurality of antenna elements to simultaneously receive signal energy in respective ones of a plurality of different directional narrowband receive beams, wherein the plurality of different directional narrowband receive beams includes the first directional narrowband receive beam, and wherein the signal energy received in the first directional narrowband receive beam is the narrowband reflection from the object. In this way, radar reflections can be simultaneously received from each of the plurality of different directions. To simplify the discussion, the focus here is on the narrowband radar reflection received in the first directional narrowband receive beam.

The line of sight signal propagation time, L, between the first and second nodes 101, 103 is known, as are their respective positions. Using this information and calculating the total propagation time of the radar signal from its point of transmission at the second node 103 to its pointer perception at the first node 101 a constant range ellipse 105 can be determined, with the first and second nodes 101, 103 constituting the foci of the ellipse 105.

At the first node 101, a receive direction of the directional narrowband receive beam is used as a first estimate of a direction of the object relative to the first node. It is also possible to use the received narrowband radar reflection signal as a basis for deriving an estimate of the object's distance from the first node 101. However, as mentioned earlier, the use of narrowband signals means that this estimate has a limited resolution which translates into an uncertainty about what the true signal propagation time, and hence distance, is. Using the minimum and maximum possible values of this coarse signal propagation time, it is possible to determine second and third ellipses 107, 109. The second and third ellipses 107, 109 are confocal ellipses having foci located at the first and second nodes 101, 103.

Using the fine angular resolution derived from the receive direction in the first node 101 and the coarse range resolution derived from the estimated signal propagation time of the narrowband radar signal, a first estimated region 111 of the object's position is determined.

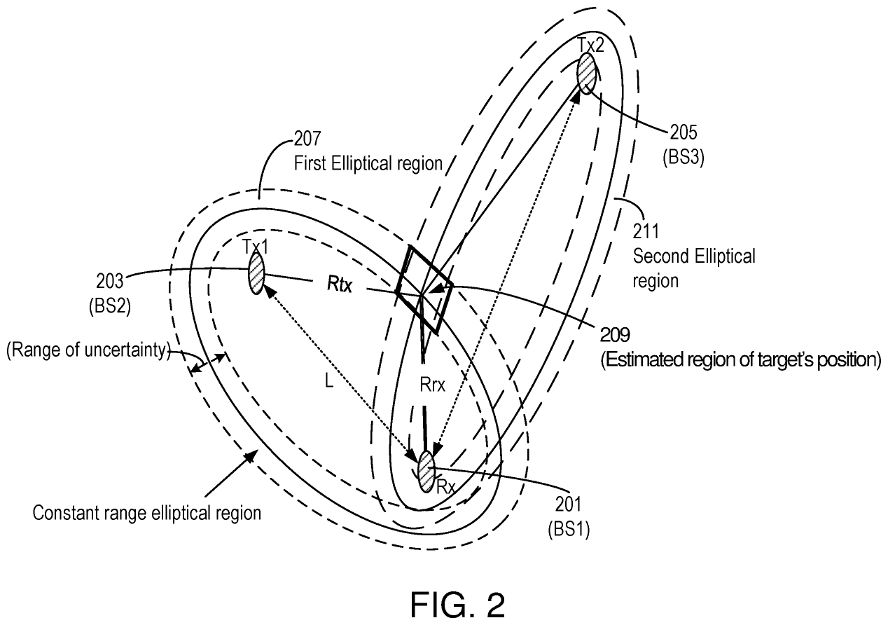

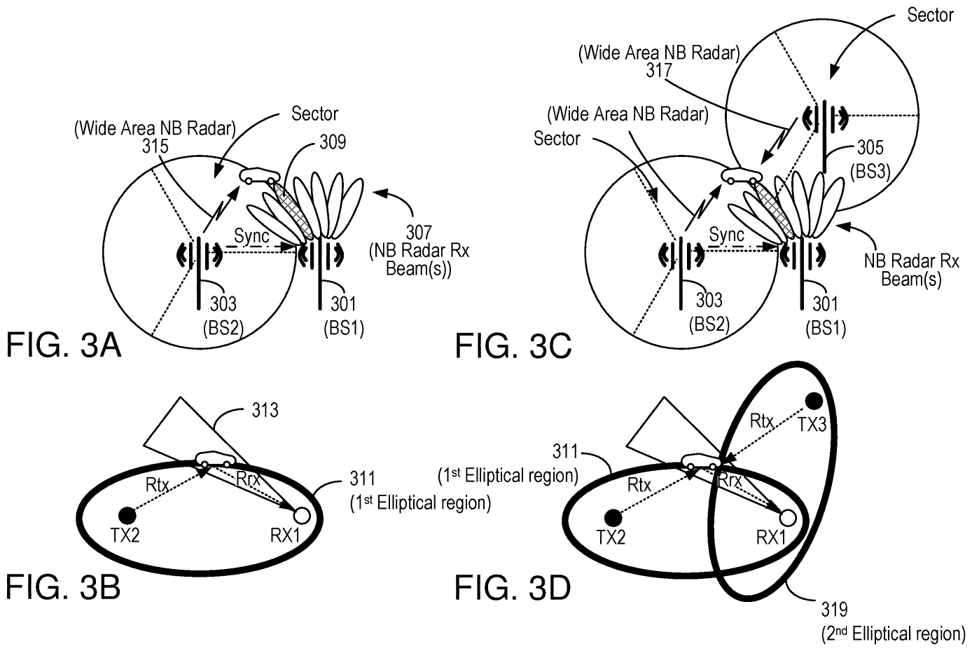

It is often desired to produce a higher resolution estimate of the object's position and further aspects of inventive embodiments address this need. In one exemplary embodiment, illustrated in FIGS. 2, 3A, 3B, 3C, and 3D, a multistatic radar strategy using three nodes is employed. In a first step, a first node 201, 301, is configured to receive radar reflection signals in each of a plurality of narrowband radar receive beams 307. A second node 203, 303, transmits a wide area narrowband radar signal 315 (e.g., within a sector, omnidirectional, etc.) and the narrowband reflection signal is received in a first one of the narrowband receive beams 309.

As shown in FIGS. 2 and 3B, knowledge of the line of sight signal propagation time, L, from the second node 203, 303 to the first node 201, 301 and the measured propagation time (Rtx+Rrx) of the reflected radar signal are used to determine a first elliptical region 207, 311 wherein the first elliptical region 207, 311 is a region between confocal ellipses having foci located at the first node 201, 301 and the second node 203, 301. From the direction of the narrowband receive beam 309, its coverage area 313 can be determined, and the intersection between this coverage area 313 and the first elliptical region 207, 311 constitutes a first estimate 209 of the position of the object. This aspect is the same as the strategy described above with respect to FIG. 1, and therefore produces only a course estimate of the position.

To improve on this, in a second step illustrated by FIGS. 2 and 3C, a third node 205, 305 also transmits a wide area narrowband signal 317 whose reflection is received in one of the first node's directional receive beams. Similar to above, and as illustrated in FIGS. 2 and 3D, the first node 201, 301 utilizes the known line of sight signal propagation time between the first node 201, 301 and the third node 205, 305 as well as the measured propagation time of the received narrowband radar reflection signal from its point of transmission at the third node 205, 305 to determine a second elliptical region 211, 319. Because narrowband signals were used here as well, and estimate of position based on the second elliptical region 211, 319 has the same level of resolution as an estimate of position based on the first elliptical region 207, 311, and this is represented schematically in FIGS. 3B and 3D by the thickness of the lines. However, an improved estimate of the object's position is found by determining the region of intersection 209 between the first elliptical region 207, 311 and the second elliptical region 211, 319. If, as illustrated in each of FIGS. 2 and 3D, the two elliptical regions intercept in more than one location, the ambiguity is easily resolved by using the known direction of the receive beam(s) in which the radar signals were received.

In the embodiments illustrated by FIGS. 2, 3A, 3B, 3C, and 3D, transmission of the radar signals from the second and third nodes 203, 303, 205, 305 and associated processing can be performed in sequence. However, since all of the signals are narrowband signals, the radar processing burden is manageable, and it is therefore feasible to have these transmissions and their respective receptions performed concurrently as long as the reflections can be identified as originating from a specific node transmission.

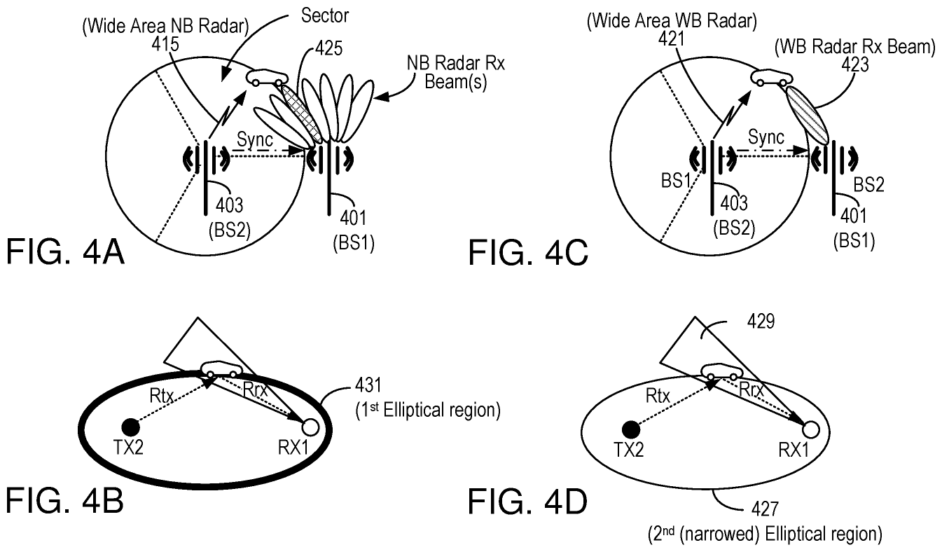

In an alternative embodiment in accordance with the invention, and with reference to FIGS. 4A, 4B, 4C, and 4D, the initial transmission of a wide area narrowband radar signal by a second node 403 and the receipt, by a first node 401, of a corresponding radar reflection signal in one of a plurality of directional receive beams are performed as described above with respect to FIGS. 3A and 3B. This embodiment differs from the earlier described one in that, in a second phase as shown in FIG. 4C, the second node 403 transmits a wide area wideband (WB) radar signal 421 instead of a narrowband one. In accordance with an aspect of this class of embodiments, the first node 401 monitors for reflected signal energy only in a directional wideband radar receive beam 423 having the same direction as the directional narrowband radar receive beam 425 in which the narrowband radar reflection was received.

The first node 401 can then determine the propagation delay of the radar reflection signal from the second node 403 to the first node 401. It also knows the line of sight signal path delay between the first and second nodes 401, 403 and from this information is able to determine a second elliptical region 427 as shown in FIG. 4D. The first node 401 is then able to find the position of the object as the region of overlap between the second elliptical region 427 and the coverage area 429 of the directional wideband radar receive beam 423.

The use of a wideband radar signal in this second phase enables a better distance resolution and hence a more accurate estimation of the distance to the reflection point of interest compared to the narrowband radar signals. This is illustrated schematically by the second elliptical region 427 drawn with a thinner line than is used to illustrate a corresponding first elliptical region 431 shown in FIG. 4B. It is noted that, while it is possible to determine the first elliptical region 431 from the information obtained in the first phase of this positioning methodology, it is not a necessary step in this embodiment, since only the directional information from that first phase is used in the second phase.

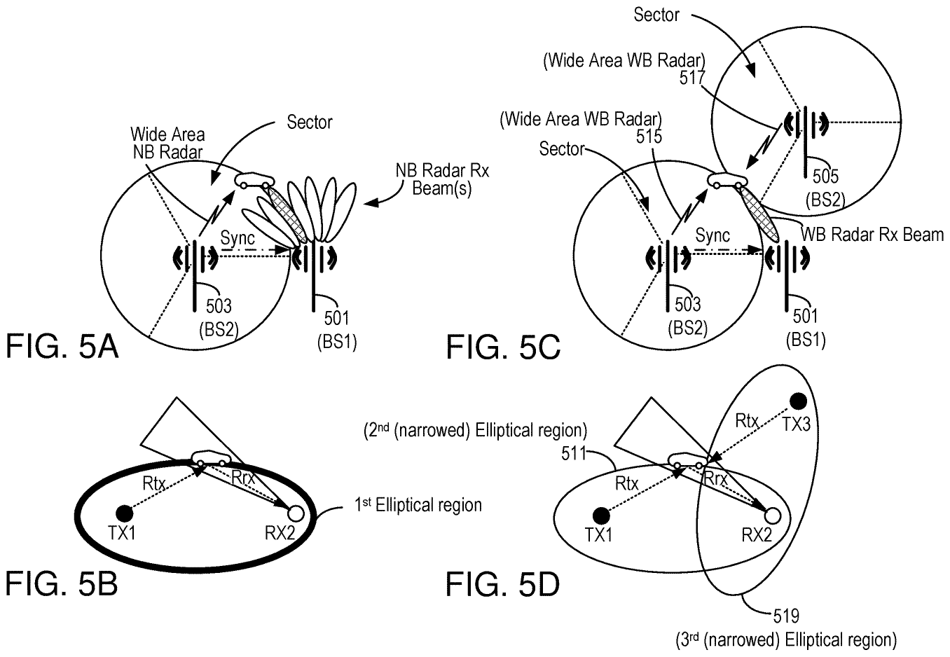

FIGS. 5A, 5B, 5C, and 5D illustrate another alternative embodiment that combines some aspects of the embodiment of FIGS. 3A, 3B, 3C, and 3D with some aspects of the embodiment of FIGS. 4A, 4B, 4C, and 4D. More particularly, in a first phase of operation (shown in FIGS. 5A and 5B), a first node 501 and a second node 503 operate the same as described earlier with respect to, for example, FIGS. 3A, 3B, 3C, and 3D. Therefore further description of this operation phase is unnecessary.

In the second phase of operation, shown in FIGS. 5C and 5D, the use of wide area wideband radar signals 515, 517 as in the embodiment of FIGS. 4C and 4D is combined with the use of two transmitting nodes 503, 505 and one receiving node 501 as in the embodiment of FIGS. 3C and 3D. This enables more accurate (narrowed) elliptical regions 511, 519 to be determined compared to the FIG. 4C configuration, with the greater accuracy deriving from the use of wideband rather than narrowband signaling.

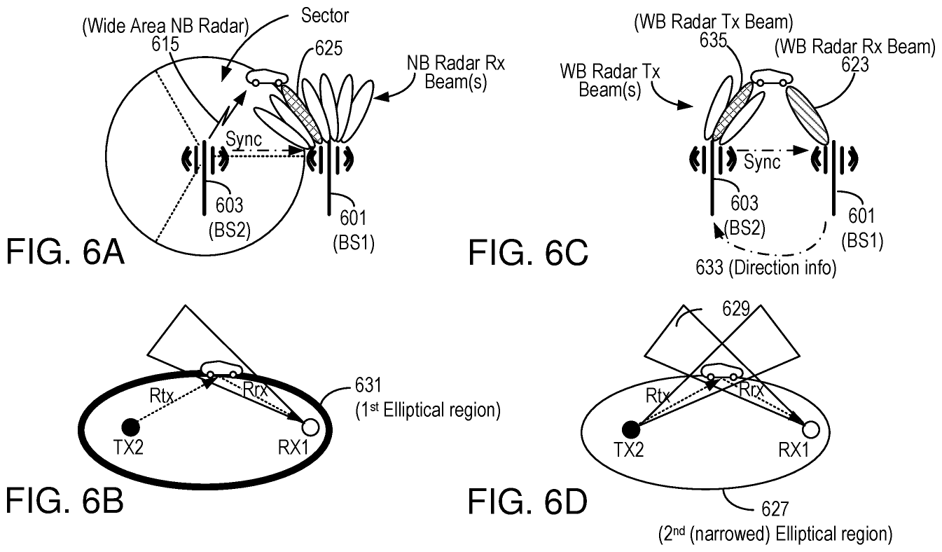

Yet another alternative embodiment is illustrated in FIGS. 6A, 6B, 6C, and 6D. FIGS. 6A and 6B illustrate a first phase of operation that is the same as described above with respect to, for example, FIGS. 4A and 4B. In particular, the initial transmission of a wide area narrowband radar signal by a second node 603 and the receipt, by a first node 601, of a corresponding radar reflection signal in one of a plurality of directional receive beams are performed as described above with respect to FIGS. 3A and 3B and also in FIGS. 4A and 4B.

As in the embodiment described above with respect to FIGS. 4C and 4D, and as illustrated here with reference to FIGS. 6C and 6D, in a second phase of operation a wideband radar signal is transmitted in one or more directional transmission beams from the second node 603 and its reflection from an object is received by the first node 601 in a directional wideband receive beam 623. The directional wideband receive beam 623 is aimed in the same direction as a directional narrowband receive beam 625 in which the narrowband radar reflection was received in the first phase of the operation. Since the expectation is that the wideband radar reflection of the second phase of operation will come from the same direction, there is no need for the first node 601 to search for radar reflections in other directions (assuming that it is not looking from reflections from other objects). And to further improve the link budget (e.g., compared to the embodiment of FIGS. 4A, 4B, 4C, and 4D), after the first phase of operation, the first node 601 communicates information 633 to the second node 603 for directing a transmit beam 635 from the second node towards the first object. To ensure that the transmitted radar signal will reflect off of the object, in some but not necessarily all embodiments, the radar signal is transmitted also from one or a few transmit beams on one or both sides of the transmit beam 635, but the coverage area of these beams is still smaller than that of a wide area signal.

As in, for example, the embodiment of FIGS. 4A, 4B, 4C, and 4D, a second elliptical region 627 as shown in FIG. 6D can be determined based on the propagation delay of the radar reflection signal from the second node 603 to the sensed object and then to the first node 601, and one or both of a known distance and the known line of sight signal path delay between the first and second nodes 601, 603. The first node 601 is then able to find the position of the object as the region of overlap between the second elliptical region 627 and the coverage area 629 of the directional wideband radar receive beam 623.

In this embodiment too, the use of a wideband radar signal in this second phase enables a much more accurate estimation of distance to be determined than is possible with the narrowband radar signals because of the higher resolution that is possible with wideband signals. This is illustrated schematically by the second elliptical region 627 being drawn with a thinner line than is used to illustrate a corresponding first elliptical region 631 derived from narrowband signals, shown in FIG. 6B.

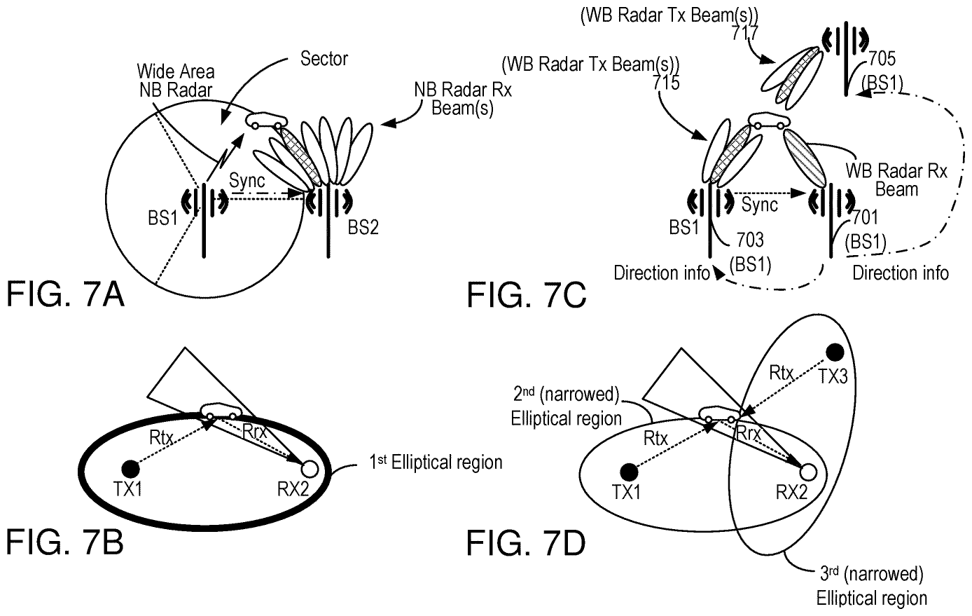

In another alternative embodiment, shown in FIGS. 7A, 7B, 7C, and 7D, the use of directional wideband transmission beams in the second phase of operation (as described with respect to FIGS. 6C and 6D) is combined with the use of plural radar transmission nodes (as described with respect to FIGS. 5C and 5D). Thus, in this embodiment the first phase of operation (illustrated in FIGS. 7A and 7B) is the same as the first phase of operation described in connection with, for example, FIGS. 6A and 6B. And in the second phase of operation (shown in FIGS. 7C and 7D), a first node 701 communicates information to each of a second node 703 and a third node 705 for enabling those nodes to aim directional wideband beams 715, 717 towards the object. In this way, the benefits of improved link budget (from the use of directional transmission beams) and higher resolution (from the use of wideband signals and plural transmission nodes) are obtained.

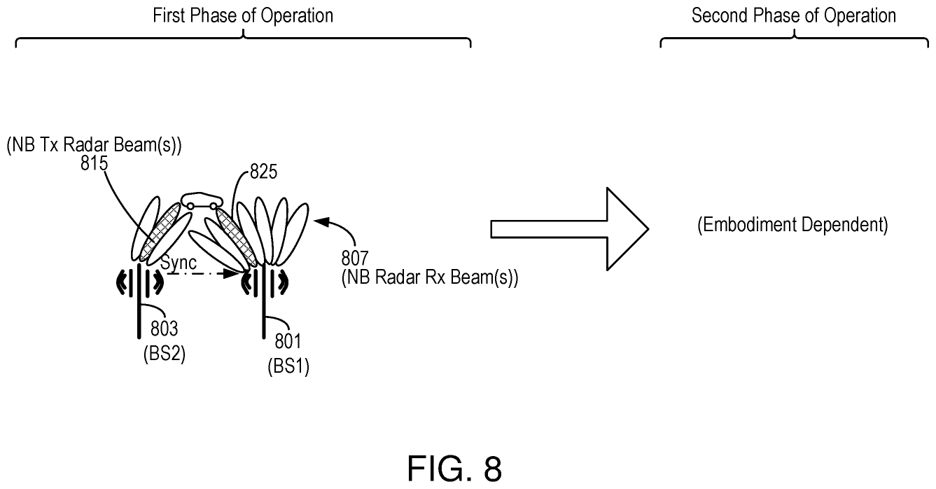

In some instances, it is necessary to operate in an environment with a poor link budget or one that is very reflective. In such instances, this is addressed in yet another embodiment as shown in FIG. 8, in which the initial transmission from a second node 803 (i.e., in the first phase of operation) is made using one or several directional narrowband transmission beams 815. If more than one transmission beam is used, separation can be made in the code domain. As described in connection with other embodiments, it is advantageous for an antenna panel of a first node 801 to be configured to enable reception through a plurality of directional narrowband receive beams 807 so that a direction of a received radar reflection will be known. Following the first phase of operation, the estimate of the object's position is improved by performing a second phase of operation as described in any of the embodiments herein. It will be further noted that in this embodiment, since the directions of both the transmission and the reception beams are known (using a narrowband receiver), the object's position can be determined without fine synchronization.

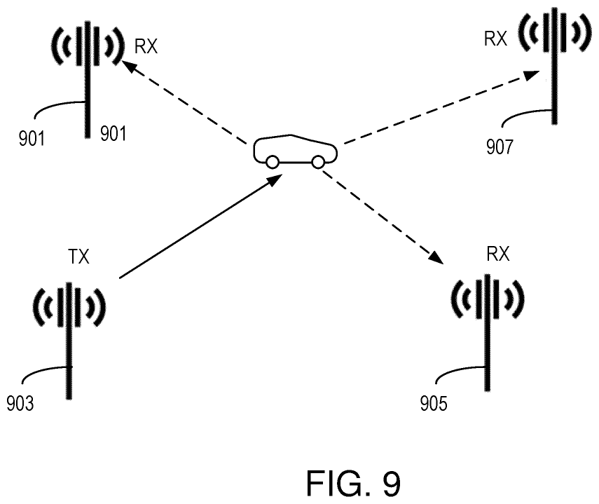

Turning now to another alternative embodiment, FIG. 9 illustrates a multistatic radar arrangement in which one node (herein denoted “second node 903”) operates as a radar signal transmitter, and in which plural other nodes (e.g., a first node 901, a third node 905, and a fourth node 907) each are configured to receive a radar reflection signal. The transmission from the second node 903 can be a wide area (e.g., sector, omnidirectional, etc.) narrowband signal. In this embodiment, only coarse synchronization between the nodes is required. All the receiving nodes 901, 905, 907 receive a reflection from the object and estimate the direction of that reflection. The object's position is determined as the point of intersection of the respective receive directions of the first, third, and fourth nodes 901, 905, 907, so this positioning methodology relies primarily on direction information from the several nodes and less on any distance measurements that may be made at individual nodes based on receipt of one radar reflection signal. Embodiments may have as few as only two receiving nodes (in addition to the one transmitting node), but it is advantageous to use more than two.

In further alternative embodiments, the technology relies on the property of beam correspondence in a network node (i.e., the property that transmission and receive beams are configured to point in the same direction).

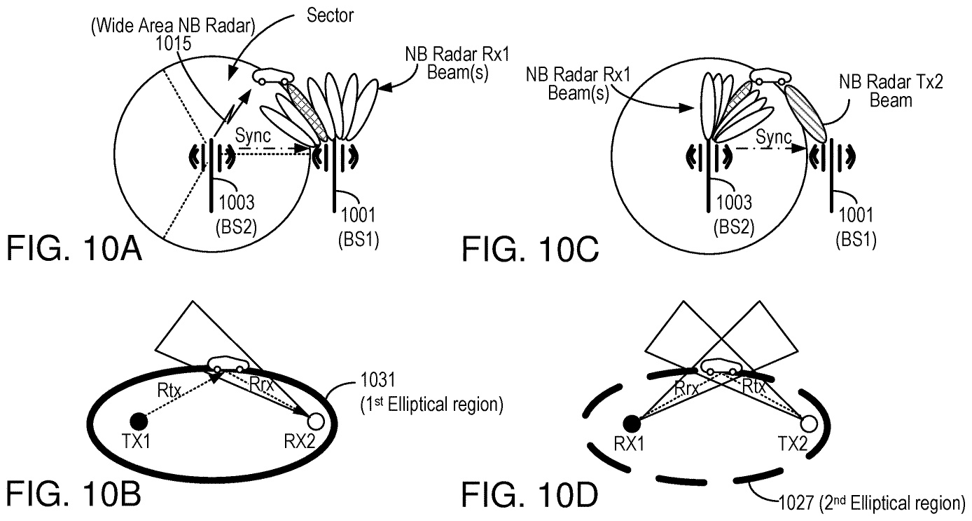

Referring to FIG. 10A, in a first phase of operation a narrow bandwidth wide area radar signal 1015 is transmitted from a second node 1003 and its reflection from an object is received in a first node 1001. By detecting the propagation time of the signal from the second node 1003 to the object and then to the first node 1001, and from knowledge of the line of sight propagation time of a signal from the second node 1003 to the first node 1001 and/or the distance between the first node 1001 and the second node 1003, a constant range elliptical region 1031 (limited by BW) as shown in FIG. 10B can be determined. In FIG. 10B, the thickness of the line schematically represents that the elliptical region occupies the area between confocal ellipses having the first and second nodes 1001, 1003 as their foci. By also deriving the receive direction from which the reflection signal was received in the first node 1001, we get the object's position can be determined as the area of intersection between the region of coverage of a directional narrowband receive beam of the first node 1001 and the elliptical region 1031.

In a second phase of operation, and as shown in FIG. 10C, the roles of the first and second nodes 1001, 1003 are reversed, with a radar signal being transmitted from the first node 1001, and the second node 1003 receiving through one or more directional narrowband receive beams in search of a radar reflection signal. Advantageously, in order to significantly improve the link budget, the principle of beam correspondence (channel reciprocity) is utilized by configuring the first node 1001 to transmit only in the dominating received object direction(s) found in the first phase of operation.

If a narrowband transmission is again used the second phase of operation, the improved link budget enables the narrowband receiver in the second node 1003 to achieve more accurate direction finding and more accurate distance estimation. The second phase of operation also improves direction resolution, especially in cases where the target is close to the second node 1003.

Since the object directions from both the first and second nodes 1001, 1003 are known, the object's position can be derived without the need for synchronization between nodes. However, such synchronization would add additional ranging information even if limited in resolution due to the use of a narrow bandwidth.

In still further alternative embodiments, even better positioning accuracy can be obtained by increasing the bandwidth of the narrowband signal, which gives better resolution in distance estimation. Better distance estimation in turn gives better absolution distance accuracy for resolved objects, but this also requires fine synchronization between the first and second nodes 1001, 1003.

Yet another variant of this example involves the use of plural, for example two, narrowband receivers in the second node. This enables the second node to simultaneously receive narrowband reflection signals at two different frequencies. Then instead of transmitting wideband as described herein in various embodiments, the first (or other) node can instead simultaneously transmit plural (e.g., two) narrowband signals that are separated in frequency (e.g., transmitting one narrowband signal at the lowest frequency in a total bandwidth and transmitting the other at the highest frequency in that bandwidth). This has the effect of creating a virtual wide bandwidth and is therefore capable of supporting a better distance resolution than just one narrowband signal. In alternative embodiments, each of several nodes can be configured to simultaneously transmit respective ones of the plural narrowband signals that are separated in frequency.

Since resolution is related only to bandwidth, having one narrowband signal the lowest frequency and one at the highest frequency within a given bandwidth actually gives a high distance resolution, the same as if the entire bandwidth had been used but with the added benefit of doing so at a lower level of complexity compared to transmitting across the entire bandwidth. In an extreme instance in which only one subcarrier is used at the high end of the bandwidth and similarly just one subcarrier at the low end, there will be ambiguity due to undersampled bandwidth. In an alternative case in which more than one subcarrier is used at each of the high and low ends of the bandwidth, the ambiguity is eliminated but such an embodiment is more sensitive to the signal-to-noise ratio (SNR). In some use cases, this might be sufficient, for example, if it is desired only to separate reflection points, or if one has some a priori information about approximately where the sensed objects are.

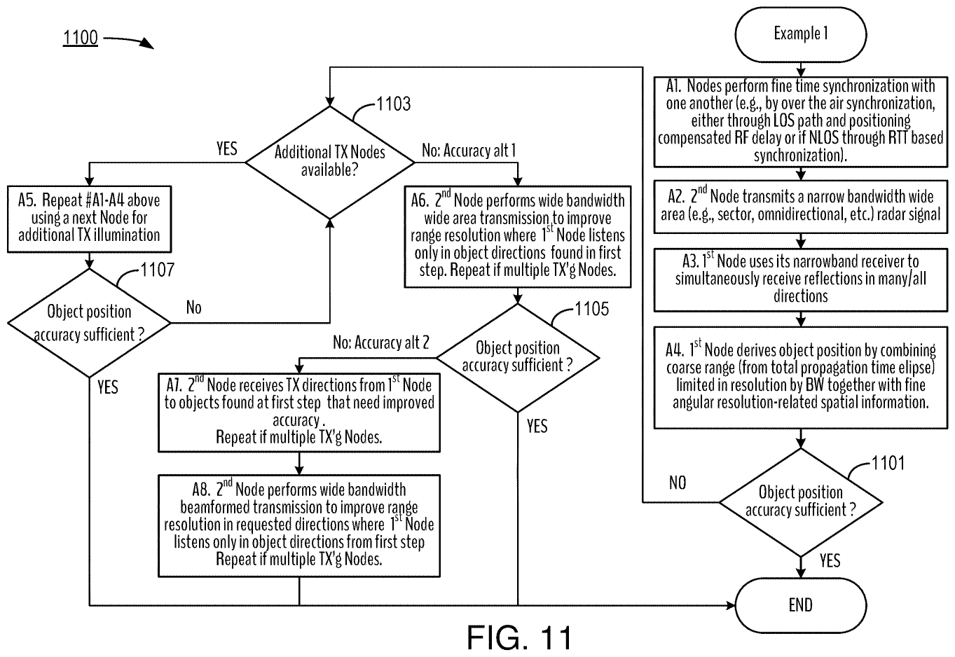

Further aspects of inventive embodiments will now be described with reference to FIG. 11, which in one respect is a flowchart of actions of plural network nodes that operate together as a bi/multistatic radar system. In other respects, the blocks depicted in FIG. 11 can also be considered to represent means 1100 (e.g., hardwired or programmable circuitry or other processing means) for carrying out the described actions.

As shown beginning in FIG. 11, the process includes the nodes performing fine time synchronization with one another (step A1). In some but not necessarily all embodiments, this is by means of over the air synchronization. Over the air synchronization can be either through line of sight (LOS) path and positioning compensated RF delay or, if non-line of sight (NLOS) signaling is employed, through Round Trip Time (RTT) based synchronization. Further alternative embodiments involve over the air synchronization that is either performed separately from the radar sensing reception (as illustrated in FIG. 11) or performed simultaneously (i.e., using a same transmitted signal for both sensing and as a synchronization reference at the receiver (which can be either a LOS or a NLOS path of the transmitted signal).

Hence methods described here are independent of synchronization method used to achieve a fine synchronization and various synchronization methods can be used in combinations. In cases where an additional step is using a wider bandwidth and for an over the air synchronization method using the same transmitted signal for both sensing and synchronization in the receiving node, the wider bandwidth also improves the synchronization. In the illustrated embodiment, a second Node then (or in some embodiments, concurrently with step A1) transmits a narrow bandwidth wide area (e.g., sector, omnidirectional, etc.) radar signal (step A2). Meanwhile, a first node uses its narrowband receiver to simultaneously receive reflections in many (or all) directions, in search of signal energy from a radar reflection (step A3).

When it detects a radar reflection in any of the directional receive beams, the first node derives an object's position by combining a coarse distance estimate (from a total propagation time ellipse) that is limited in resolution by use of the narrow bandwidth radar signal, together with fine angular resolution-related spatial information (e.g., from knowledge of which receive beam the reflection was received in) (step A4).

If the estimated position is of sufficient accuracy to satisfy application requirements (“Yes” path out of decision block 1101), the process is terminated.

If the estimated position is not sufficiently accurate for its intended use (“No” path out of decision block 1101) then further actions are taken. If there are no additional nodes available to serve as transmitting nodes beyond those that have already been employed in the radar operation (“No” path out of decision block 1103), then the second node transmits a wide area, wide bandwidth radar signal in order to improve range resolution. Concurrently, the first node listens only in object directions found in step A4. Repeat if there are multiple transmitting nodes. A new (higher resolution) estimate of the object's information is then derived from this information. If the new position estimate is sufficiently accurate (“Yes” path out of decision block 1105), then the process terminated.

But if even higher accuracy is needed (“No” path out of decision block 1105), then still further actions are taken. More particularly, for any object whose position needs to be estimated with higher resolution, the first node communicates object directional information (derived from an earlier positioning action) to the second node, where the directional information enables the second node to aim a transmit beam towards the object (step A7). Repeat if multiple TX′g Nodes.

The second node then aims a transmission beam towards the object, and performs a wide bandwidth radar transmission in that direction, while the first node, using one or more receive beams aimed at the object (based on direction information derived in an earlier phase of operation), listens for a wideband radar reflection (step A8). Repeat if multiple TX′g Nodes.

Returning to decision block 1103, if more than two nodes are available to participate (assume there are N nodes available to act as transmitting nodes), or if two nodes are configured to swap roles after a first step, so that in a first step one node transmits while the other receives and then in a second step their roles are reversed, then steps A1 through A4 are repeated for a third node (step A5). This yields a new estimate of the object's position, and the level of accuracy of this estimate is assessed (decision block 1107). If it is not sufficiently accurate (“No” path out of decision block 1107), then processing reverts back to decision block 1103 to determine whether there are still more nodes available to act as transmitting nodes. If not (“No” path out of decision block 1103), then processing continues at step A6, which is described above. But if there are additional transmitting nodes available (“Yes” path out of decision block 1103, the next node participates as a transmitter in the multistatic radar process (step A5). If it is eventually decided that the object's position is sufficiently accurate (“Yes” path out of decision block 1107), then the process terminates.

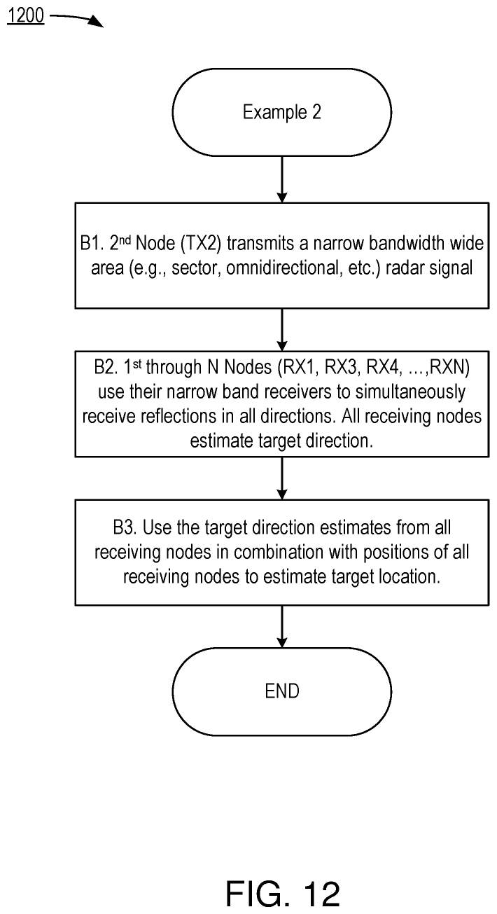

Further aspects of inventive alternative embodiments will now be described with reference to FIG. 12, which in one respect is a flowchart of actions of plural network nodes that operate together as a multistatic radar system in a system having a transmitting node and plural receiving nodes such as, but not limited to, the embodiment illustrated in FIG. 9. In other respects, the blocks depicted in FIG. 12 can also be considered to represent means 1200 (e.g., hardwired or programmable circuitry or other processing means) for carrying out the described actions. For consistency in this document, a transmitting node is denoted “second node”, and a receiving node is denoted “first node”. Remaining receiving nodes are denoted “third node”, “fourth node”, . . . , “N^{th} node”.

As shown beginning in FIG. 12, the process includes the second node transmitting a narrow bandwidth, wide area (e.g., sector, omnidirectional, etc.) radar signal (step B1).

Concurrently, each of the receiving nodes (first and third through N^{th} nodes) uses its narrow bandwidth receiver to sense signal energy in many directions to find one that includes a radar reflection signal. Each node estimates the object's direction (relative to the node) from that action (step B2). The estimates of the object's direction in conjunction with knowledge of each node's position are then used to estimate the object's position (e.g., by determining a region of intersection of direction vectors originating at each of the receiving nodes) (step B3).

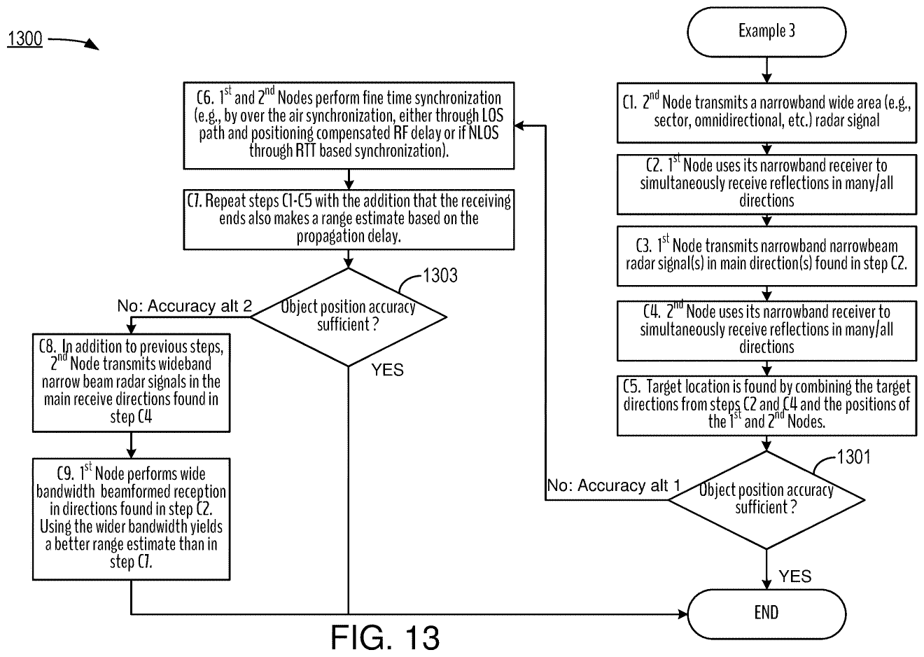

Further aspects of other inventive alternative embodiments will now be described with reference to FIG. 13, which in one respect is a flowchart of actions of plural network nodes that operate together as a bi/multistatic radar system in a system that operates in a manner such as that shown in FIGS. 10A, 10B, 10C, and 10D. In other respects, the blocks depicted in FIG. 13 can also be considered to represent means 1300 (e.g., hardwired or programmable circuitry or other processing means) for carrying out the described actions.

As shown beginning in FIG. 13, the process includes a first phase of operation in which the second node transmits a narrowband wide area (e.g., sector, omnidirectional, etc.) radar signal (step C1). Concurrently, the first node uses its narrowband receiver to search in many directions (e.g., via plural receive beams) for signal energy related to a reflection of the transmitted radar signal (step C2). The main one or more directions of the object (relative to the first node) are found from the received reflection(s).

The roles of the nodes as transmitter and receiver are then reversed, with the first node transmitting narrowband radar signals in the main direction (main several directions) identified in step C2 (step C3), while the second node uses its narrowband receive to simultaneously receive signal energy in many (or all) directions in search of reflections from the transmitted radar signal(s) (step C4). The main one or more directions of the object (relative to the second node) are found from the received reflection(s).

The object's location is found by combining information about the directions found in steps C2 and C4 and the known positions of the first and second nodes (e.g., finding the region of intersection between direction vectors having respective origins at the first and second nodes) (step C5).

In decision block 1301, it is determined whether the accuracy of the position is sufficient. What constitutes sufficiency is application and/or environment dependent. Further aspects of “sufficiency” are discussed below. When it is determined that the position of the object is determined with sufficient accuracy (“Yes” path out of decision block 1301), the process is terminated.

When the determined accuracy of the position as determined at step C5 is not sufficient for purposes of the intended application (“No” path out of decision block 1301), then the first and second nodes perform fine time synchronization with one another by means (step C6). In some but not necessarily all embodiments, synchronization is achieved by over the air synchronization signaling, either through LOS path signaling and positioning compensated RF delay, or, if in an NLOS environment, through RTT based synchronization.

Following fine time synchronization, steps C1 through C5 are repeated but with the addition that the receiving ends also make a distance estimate (relative to the node doing the receiving) based on the propagation delay (step C7). (In some but not all alternative embodiments, steps C6 and C7 are performed concurrently.) This enables a new position estimate to be made, and this is then tested to determine if it is sufficiently accurate (decision block 1303). If it is (“Yes” path out of decision block 1303), then the process terminates.

But if even more accuracy is required (“No” path out of decision block 1303), then the second node configures one or more transmit beams in the main one or more directions found in step C4, and uses these to transmit wideband radar signals (step C8). Concurrently, the first node configures one or more receive beams in the main one or more directions found in step C2 and receives wideband reflection signals to obtain a more accurate estimation of the distance to the object (step C9).

In some alternative embodiments based on the flowchart of FIG. 13, if simultaneous radar sensing and synchronizing signal reception are used as a synchronization method, then steps C6 and C7 are not needed since fine synchronization can be performed embedded at step C9. This type of synchronization would also benefit from the wider bandwidth used in steps C8 and C9.

It is noted that in a number of instances (e.g., in connection with FIGS. 11 and 13), some actions are based on whether or not the object's position has been determined to a sufficiently accurate level. In this respect, sufficiency of position accuracy is dependent on application and/or use case, and can take into consideration one or more of:
radar operation mode (e.g., tracking mode or detecting mode)
user scenario (e.g., what is the location of the object used for)
relation between objects (e.g., whether they are close or far apart)
environment and its characteristics around an object
object mobility.

To illustrate this by way of example, consider the fact that differing geometry associated with different locations can result in errors that are larger in some places than in others (i.e., due to measurement errors and/or higher sensitivity to errors). Applying this to the class of embodiments illustrated in FIG. 11, an object's position is detected at step A4. The test at decision block 1101 can then include a test to determine whether the detected position is within a specific critical area that requires a more precise determination of location than is needed in other areas.

In a variation, it may be the case that particular objects are more sensitive to measurement errors in some locations than they are at others. The test at decision block 1101 might then further include a test to see if a detected object is included within a class of objects requiring higher precision location determination (possibly only when in certain locations).

It will be appreciated that in still further alternative embodiments, a required degree of sensing accuracy may be known at the outset, in which case it may be unnecessary to perform multiple radar sensings at various degrees of accuracy until a sufficient accuracy is achieved (e.g., as illustrated with reference to FIGS. 11 and 13). For example, a radar-quality-of-service (RQS) may be indicated at the outset in a radar service request.

Since the radar will use communication resources, there is a tradeoff between RQS and reduced communication capacity. Exemplary RQS parameters include, but are not limited to:
maximum distance
minimum distance
distance resolution
directional resolution
maximum doppler
minimum radar-cross-section.

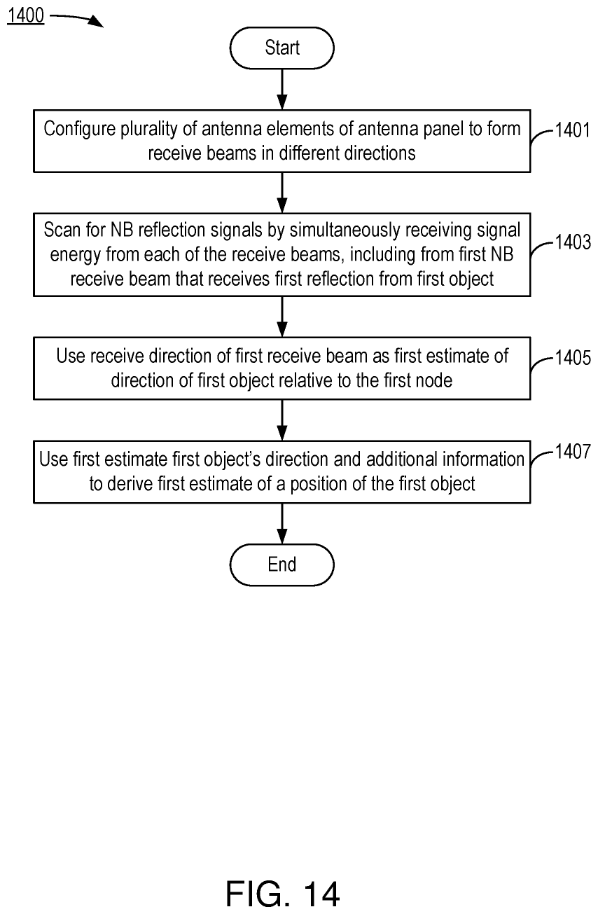

Further aspects of other inventive alternative embodiments will now be described with reference to FIG. 14, which in one respect is a flowchart of actions of plural network nodes that operate together as a bi/multistatic radar system. In other respects, the blocks depicted in FIG. 13 can also be considered to represent means 1400 (e.g., hardwired or programmable circuitry or other processing means) for carrying out the described actions.

As shown beginning in FIG. 14, the process includes a first node configuring a plurality of antenna elements of an antenna panel to form receive beams pointing in different respective directions (step 1401).

The first node then uses the narrowband receiver and the configured plurality of antenna elements to simultaneously receive signal energy in respective ones of a plurality of different directional receive beams, wherein the plurality of different directional receive beams includes a first directional receive beam, and wherein the signal energy received in the first directional receive beam is a first narrowband reflection from the first object (step 1403).

A receive direction of the first directional receive beam is then used as a first estimate of a direction of the first object relative to the first node (step 1405).

The first estimate of the direction of the first object and additional information are then used to derive a first estimate of a position of the first object, wherein the first estimate of the position of the first object is a geographical region (step 1407). The additional information in this step can be obtained as described in any of the various embodiments described herein.

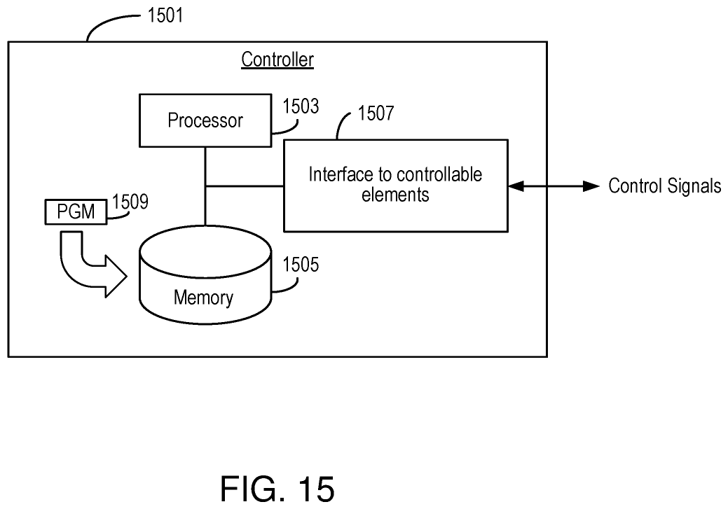

Further aspects of embodiments consistent with the invention will now be described with reference to FIG. 15, which shows an exemplary controller 1501 that may be included in a network node to cause any and/or all of the herein-described and illustrated actions to be performed. In particular, the controller 1501 includes circuitry configured to carry out any one or any combination of the various functions described herein. Such circuitry could, for example, be entirely hard-wired circuitry (e.g., one or more Application Specific Integrated Circuits “ASICs”). Depicted in the exemplary embodiment of FIG. 9, however, is programmable circuitry, comprising a processor 1503 coupled to one or more memory devices 1505 (e.g., Random Access Memory, Magnetic Disc Drives, Optical Disk Drives, Read Only Memory, etc.) and to an interface 1507 that enables bidirectional communication with other elements of a node or other nodes in a communication system. A complete list of possible other elements is beyond the scope of this description.

The memory device(s) 1505 store program means 1509 (e.g., a set of processor instructions) configured to cause the processor 1503 to control other device elements so as to carry out any of the aspects described herein. The memory device(s) 1505 may also store data (not shown) representing various constant and variable parameters as may be needed by the processor 1503 and/or as may be generated when carrying out its functions such as those specified by the program means 1509.

With respect to all of the exemplary embodiments described above, further aspects include making multiple radar measurements and finding the phase shifts in between the measurements. This information enables determination of the speed of sensed object. This requires phase stability between the transmitter and receiver because a frequency error between the nodes would otherwise cause a stationary object to incorrectly be interpreted as a moving object. One exemplary way of addressing this is using the earlier described over the air synchronization technique in which a same transmitted signal is used both for time synchronization and for ranging/distance estimates in addition also as a stable phase synchronization reference.

It is to be noted that, in order to facilitate the description of inventive aspects, all of the above-described exemplary embodiments present simplified use cases. Those of ordinary skill in the art will appreciate that in a real-world use case, there will be clutter and many reflections.

More advanced algorithms, possibly enhanced by machine learning, should be employed for good positioning estimation, but the fundamental technological approaches will be the same.

Embodiments consistent with the invention provide advantages over conventional technology. Such advantages include:
Faster radar response time
Less resource utilization

The invention has been described with reference to particular embodiments. However, it will be readily apparent to those skilled in the art that it is possible to embody the invention in specific forms other than those of the embodiment described above.

For example, and without limitation, actions described with respect to various embodiments can be combined in many different ways. Taking embodiments described with reference to FIG. 6 as a basis for illustrating this point, embodiments consistent with the invention can have an intermediate step involving the use of narrowband signals, since it is less complex, and one could stop there if estimates are sufficiently accurate. For example, embodiments can comprise the following actions:
1. The second node 603 transmits Wide Area narrowband radar signals.
2. The first node 601 finds narrowband beams.
3. The first node 601 communicates directions to the second node 603.
4. The second node 603 transmits a narrowband beam in those found directions and the first node 601 receives resulting reflections.
5. The second node 603 transmits a wideband beam in those directions and the first node 601 receives resulting reflections.

In some cases it may be sufficient to stop after performing step #4 because even though this step does not give an improved distance resolution, an advantage is that narrowband beams can be transmitted simultaneously in multiple directions (and reflections from multiple directions received and the presence of objects identified in the direction information). But if a better estimate of an object's distance is desired, then step #5 (involving wideband signals) can be performed.

Thus, the described embodiments are merely illustrative and should not be considered restrictive in any way. The scope of the invention is further illustrated by the appended claims, rather than only by the preceding description, and all variations and equivalents which fall within the range of the claims are intended to be embraced therein.

1.-33. (canceled)

34. A method of radar sensing a first object in a cellular communication system that comprises a first node, the method comprising:
using a narrowband receiver of the first node to simultaneously receive a plurality of different directional narrowband receive beams;
identifying therefrom a first directional narrowband receive beam, wherein a first signal received in the first directional narrowband receive beam is associated with a first reflection from the first object;
using a receive direction of the first directional narrowband receive beam as a first estimate of a direction of the first object relative to the first node; and
using the first estimate of the direction of the first object and additional information to derive a first estimate of a position of the first object.

35. The method of claim 34, wherein the first reflection from the first object is a reflection of a first signal transmitted by a second node of the cellular communication system, and wherein the additional information comprises relative positions of the first node and the second node and a signal propagation time from a radar transmitter of the second node to the first object and then to the first node, which together are usable to determine a first elliptical region.

36. The method of claim 35, wherein the first signal transmitted by the second node is a first wide area narrowband signal.

37. The method of claim 34, further comprising:
using a wideband radio receiver of the first node to receive a first directional wideband receive beam, wherein the first directional wideband receive beam has a direction based on a direction of the first directional narrowband receive beam, wherein a second signal received in the first directional wideband receive beam is associated with a second reflection from the first object; and
using the second signal received in the first directional wideband receive beam to determine a refined estimate of the position of the first object.

38. The method of claim 37, wherein the second reflection from the first object is a reflection of a second signal transmitted by the second node of the cellular communication system.

39. The method of claim 35, further comprising using the narrowband radio receiver of the first node to receive a second directional narrowband receive beam, wherein the second directional narrowband receive beam has a direction that is based on the direction of the first directional narrowband receive beam, wherein a third signal received in the second directional narrowband receive beam is associated with a third reflection from the first object, wherein the third reflection from the first object is a reflection of a third signal transmitted by a third node of the cellular communication system, and wherein the additional information comprises relative positions of the first node and the third node and a signal propagation time from a radar transmitter of the third node to the first object and then to the first node, which together are usable to determine a second elliptical region.

40. The method of claim 39, further comprising determining the position of the first object to be in a region of overlap between the first elliptical region and the second elliptical region.

41. The method of claim 39, wherein the third reflection from the first object is a reflection of a second narrowband signal transmitted by the third node of the cellular communication system.

42. The method of claim 34, further comprising receiving a further narrowband reflection from the first object, wherein the further narrowband reflection is separated in frequency from the first narrowband reflection.

43. An apparatus for radar sensing a first object in a cellular communication system that comprises a first node, the apparatus comprising circuitry configured to cause:
using a narrowband receiver of the first node to simultaneously receive a plurality of different directional narrowband receive beams;
identifying therefrom a first directional narrowband receive beam, wherein a first signal received in the first directional narrowband receive beam is associated with a first reflection from the first object;
using a receive direction of the first directional narrowband receive beam as a first estimate of a direction of the first object relative to the first node; and
using the first estimate of the direction of the first object and additional information to derive a first estimate of a position of the first object.

44. The apparatus of claim 43, wherein the first reflection from the first object is a reflection of a first signal transmitted by a second node of the cellular communication system, and wherein the additional information comprises relative positions of the first node and the second node and a signal propagation time from a radar transmitter of the second node to the first object and then to the first node, which together are usable to determine a first elliptical region.

45. The apparatus of claim 44, wherein the first signal transmitted by the second node is a first wide area narrowband signal.

46. The apparatus of claim 43, wherein the circuitry is further configured to cause:
using a wideband radio receiver of the first node to receive a first directional wideband receive beam, wherein the first directional wideband receive beam has a direction based on a direction of the first directional narrowband receive beam, wherein a second signal received in the first directional wideband receive beam is associated with a second reflection from the first object; and
using the second signal received in the first directional wideband receive beam to determine a refined estimate of the position of the first object.

47. The apparatus of claim 46, wherein the second reflection from the first object is a reflection of a second signal transmitted by the second node of the cellular communication system.

48. The apparatus of claim 44, wherein the circuitry is further configured to cause using the narrowband radio receiver of the first node to receive a second directional narrowband receive beam, wherein the second directional narrowband receive beam has a direction that is based on the direction of the first directional narrowband receive beam, wherein a third signal received in the second directional narrowband receive beam is associated with a third reflection from the first object, wherein the third reflection from the first object is a reflection of a third signal transmitted by a third node of the cellular communication system, and wherein the additional information comprises relative positions of the first node and the third node and a signal propagation time from a radar transmitter of the third node to the first object and then to the first node, which together may be used to determine a second elliptical region.

49. The apparatus of claim 48, wherein the circuitry is further configured to cause determining the position of the first object to be in a region of overlap between the first elliptical region and the second elliptical region.

50. The apparatus of claim 48, wherein the third reflection from the first object is a reflection of a second narrowband signal transmitted by the third node of the cellular communication system.

51. The apparatus of claim 43, wherein the circuitry is further configured to cause receiving a further narrowband reflection from the first object, wherein the further narrowband reflection is separated in frequency from the first narrowband reflection.

52. A base station for use in a cellular communication system, wherein the base station comprises the apparatus of claim 43.
